(19) United States
(12) Patent Application Publication
(10) Pub. No.: US 2023/0174394 A1
(43) Pub. Date: Jun. 8, 2023

(54) TREATMENT OF SLURRY COPPER WASTEWATER WITH ULTRAFILTRATION AND ION EXCHANGE

(71) Applicant: Evoqua Water Technologies LLC, Pittsburgh, PA (US)

(72) Inventors: JEFFREY W. MARTIN, Freedom, PA (US); FRANK L. SASSAMAN, Fombell, PA (US)

(73) Assignee: Evoqua Water Technologies LLC, Pittsburgh, PA (US)

(21) Appl. No.: 17/920,050

(22) PCT Filed: Apr. 7, 2021
(86) PCT No.: PCT/US2021/026096

§ 371 Date: Oct. 20, 2022

Related U.S. Application Data
(60) Provisional application No. 63/006,269, filed on Apr. 7, 2020.

(51) Int. Cl. C02F 1/44; C02F 1/42; C02F 1/62; C02F 1/66

(52) U.S. Cl. CPC C02F 1/444; C02F 1/42; C02F 1/62; C02F 1/66; C02F 2101/20

(57) ABSTRACT

A method for treating a waste stream from a copper CMP process including dissolved copper and abrasive particles having a number weighted mean size of less than 0.75 μm includes introducing the waste stream into a feed tank, flowing the waste stream from the feed tank into an ultrafiltration module, filtering the waste stream through a membrane of the ultrafiltration module to form a solids-lean filtrate, directing the solids-lean filtrate from the ultrafiltration module through an ion exchange unit to remove dissolved copper and produce a treated aqueous solution having a lower copper concentration than the copper concentration of the waste stream, backwashing the membrane ultrafiltration module to remove the slurry solids from the membrane of the ultrafiltration module, and combining the removed slurry solids with the treated aqueous solution to form a combined discharge stream having a copper concentration suitable for discharge into the environment.

### CROSS-REFERENCE TO RELATED APPLICATIONS

This application claims priority under 35 U.S.C. § 119(e) to U.S. Provisional Patent Application Ser. No. 63/006,269 titled “TREATMENT OF SLURRY COPPER WASTEWATER WITH ULTRAFILTRATION AND ION EXCHANGE”, filed Apr. 7, 2020, the entire contents of which are incorporated herein by reference.

### BACKGROUND

Aspects and embodiments disclosed herein relate to systems and methods for reducing the concentration of one or more metal species from a waste stream and, in particular, to a system and apparatus for removing one or more metal species from chemical mechanical planarization waste slurry streams.

### SUMMARY

In accordance with one aspect, there is provided a method for treating an aqueous waste stream from a copper chemical mechanical polishing process including a concentration of dissolved copper and slurry solids comprising abrasive particles having a number weighted mean size of less than 0.75 μm. The method comprises introducing the aqueous waste stream into a feed tank, flowing the aqueous waste stream from the feed tank into an ultrafiltration module, filtering the aqueous waste stream through a membrane of the ultrafiltration module to form a solids-lean filtrate, directing the solids-lean filtrate from the ultrafiltration module through an ion exchange unit to remove dissolved copper and produce a treated aqueous solution having a lower copper concentration than the copper concentration of the aqueous waste stream, backwashing the membrane ultrafiltration module to remove the slurry solids from the membrane of the ultrafiltration module, and combining the removed slurry solids with the treated aqueous solution to form a combined discharge stream having a copper concentration suitable for discharge into the environment.

In some embodiments, the method further comprises directing the solids-lean filtrate from the ultrafiltration module into a filtrate holding tank and directing the solids-lean filtrate from the filtrate holding tank to the ion exchange unit.

In some embodiments, backwashing the ultrafiltration module includes backwashing the membrane of the ultrafiltration module with the solids-lean filtrate from the filtrate holding tank.

In some embodiments, the method further comprises directing the solids-lean filtrate used to backwash the ultrafiltration module and the removed slurry solids into a backwash holding tank.

In some embodiments, the method further comprises settling the removed slurry solids in the backwash holding tank.

In some embodiments, the method further comprises directing supernatant from the backwash holding tank into the feed tank.

In some embodiments, the method further comprises adjusting a pH of the aqueous waste stream in the feed tank.

In some embodiments, adjusting the pH of the aqueous waste stream in the feed tank comprises adjusting the pH of the aqueous waste stream to a pH of about 3.

In some embodiments, filtering the aqueous waste stream through the membrane of the ultrafiltration module include filtering about 40 gallons of the aqueous waste stream per square foot of membrane area per day (GFD) through the membrane of the ultrafiltration module while maintaining an inlet pressure of the ultrafiltration module below about 1.5 pounds per square inch.

In some embodiments, backwashing of the ultrafiltration module is performed after a predetermined amount of time of filtering the aqueous waste stream in each cycle of filtration and backwash.

In some embodiments, introducing the aqueous waste stream into the feed tank includes introducing an aqueous waste stream having a concentration of the abrasive particles with sizes of 0.50 μm and above of at least 10⁶/ml.

In accordance with another aspect, there is provided a method of facilitating treatment of an aqueous waste stream from a copper chemical mechanical polishing process including a concentration of dissolved copper and slurry solids comprising abrasive particles having a number weighted mean size of less than 0.75 μm. The method comprises providing an ultrafiltration module, an ion exchange module, and a backwash holding tank, fluidly connecting the ultrafiltration module upstream of the ion exchange module, fluidly connecting the backwash holding tank to a backwash outlet of the ultrafiltration module, fluidly connecting a solids outlet of the backwash holding tank to an outlet of the ion exchange module, and fluidly connecting a supernatant outlet of the backwash holding tank to an inlet of the ultrafiltration module.

In accordance with another aspect, there is provided a system for treating an aqueous waste stream from a copper chemical mechanical polishing process including a concentration of dissolved copper and slurry solids comprising abrasive particles having a number weighted mean size of less than 0.75 μm. The system comprises a feed tank fluidly connectable to a source of the aqueous waste stream, an ultrafiltration unit having an inlet fluidly connectable to an outlet of the feed tank, an ion exchange unit including media operable to remove copper from a stream passing through the ion exchange unit and having an inlet fluidly connectable to a filtrate outlet of the ultrafiltration unit, and a backwash holding tank having an inlet fluidly connectable to a backwash outlet of the ultrafiltration unit, a settled solids outlet fluidly connectable to a purified water outlet of the ion exchange unit, and a supernatant outlet fluidly connectable to the feed tank.

In some embodiments, the system further comprises a filtrate holding tank fluidly connectable between the filtrate outlet of the ultrafiltration unit and the inlet of the ion exchange unit.

In some embodiments, the system further comprises a backwash pump configured to direct filtrate from the filtrate holding tank through the ultrafiltration unit and into the backwash holding tank.

In some embodiments, the system further comprises a controller configured to cause the system to perform a method comprising introducing the aqueous waste stream into the feed tank, flowing the aqueous waste stream from the feed tank into the ultrafiltration unit, filtering the aqueous waste stream through a membrane of the ultrafiltration unit to form a solids-lean filtrate, directing the solids-lean filtrate from the ultrafiltration unit through the ion exchange unit to produce a treated aqueous solution having a lower copper concentration than the copper concentration of the aqueous waste stream, backwashing the membrane of the ultrafiltration unit to remove slurry solids from the membrane of the ultrafiltration unit, and combining the removed retained solids with the treated aqueous solution to form a combined discharge stream having a copper concentration suitable for discharge into the environment. In some embodiments, the controller is further configured to cause the system to settle the removed slurry solids in the backwash holding tank.

In some embodiments, the controller is further configured to cause the system to adjust a pH of the aqueous waste stream in the feed tank.

In some embodiments, the controller is further configured to cause the system to adjust the pH of the aqueous waste stream in the feed tank to a pH of about 3.

In some embodiments, the controller is further configured to cause the system to filter about 40 gallons of the aqueous waste stream per square foot of membrane area per day (GFD) through the membrane of the ultrafiltration unit while maintaining an inlet pressure of the ultrafiltration unit below about 1.5 pounds per square inch.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawing:

FIG. 1A illustrates measured particle sizes of particles of abrasive material in samples of waste slurry from a copper (Cu) chemical mechanical polishing (CMP) process;

FIG. 1B illustrates measured concentrations of particles of abrasive material in samples of waste slurry from a Cu CMP process;

FIG. 2 is a schematic illustration of a CMP slurry waste treatment system in accordance with one or more embodiments of the invention;

FIG. 3 illustrates calculations to determine a total Cu concentration in effluent from an example Cu CMP slurry waste treatment system;

FIG. 4 illustrates the configuration of a system used for evaluating various methods of operating an ultrafilter to filter different samples of Cu CMP slurry;

FIG. 5 illustrates directions of fluid flow into and out of an ultrafilter during Cu CMP slurry filtration and backwash evaluation;

FIG. 6 illustrates steps in a chemically enhanced backwash of the ultrafilter used for the filtration evaluation;

FIG. 7A is a chart of time versus inlet pressure while operating the ultrafilter for filtration of Cu CMP slurry under a first set of conditions;

FIG. 7B is a chart of time versus inlet pressure while operating the ultrafilter for filtration of Cu CMP slurry under another set of conditions;

FIG. 7C is a chart of time versus inlet pressure while operating the ultrafilter for filtration of Cu CMP slurry under another set of conditions;

FIG. 7D is a chart of time versus inlet pressure while operating the ultrafilter for filtration of Cu CMP slurry under another set of conditions;

FIG. 7E is a chart of time versus inlet pressure while operating the ultrafilter for filtration of Cu CMP slurry under another set of conditions;

FIG. 7F is a chart of time versus inlet pressure while operating the ultrafilter for filtration of Cu CMP slurry under another set of conditions;

FIG. 7G is a chart of time versus inlet pressure while operating the ultrafilter for filtration of Cu CMP slurry under another set of conditions;

FIG. 7H is a chart of time versus inlet pressure while operating the ultrafilter for filtration of Cu CMP slurry under another set of conditions; and

FIG. 7I is a chart of time versus inlet pressure while operating the ultrafilter for filtration of Cu CMP slurry under another set of conditions.

### DETAILED DESCRIPTION

Semiconductor microelectronic chip (microchip) manufacturing companies have developed advanced manufacturing processes to shrink electronic circuitry on a microchip to smaller dimensions. The smaller circuitry dimensions involve smaller individual minimum feature sizes or minimum line widths on a single microchip. The smaller minimum feature sizes or minimum line widths provide for fitting more computer logic onto the micro-chip.

Many modern semiconductor manufacturing processes use copper (Cu) in place of older aluminum-based processes to create Cu microchip circuitry on a silicon wafer. Copper has an electrical resistance lower than aluminum, thereby providing a microchip which can operate at much faster speeds with lower heat buildup than microchips utilizing aluminum for electrical conductors in the microchip. The Cu is introduced to Ultra Large Scale Integration (ULSI) and Complimentary Metal Oxide Semiconductor (CMOS) silicon structures and is utilized as interconnect material and for vias and trenches on these silicon structures. For fully integrated multi-level integrated circuit micro-chips, Cu now is the preferred interconnect material.

ULSI silicon structures are integrated circuits containing more than 1,000,000 transistors. CMOS silicon structures are integrated circuits containing n-type metal oxide semiconductor (N-MOS) and p-type metal oxide semiconductor (P-MOS) transistors on the same substrate.

Chemical mechanical polishing (CMP) planarization of Cu metal layers is used as a part of many modern semiconductor manufacturing processes. The CMP planarization produces a flat substrate working surface for the microchip. Current technology does not etch Cu effectively, so the semiconductor fabrication facility tool employs a polishing step to prepare the silicon wafer surface.

Chemical mechanical polishing of integrated circuits involves a planarization of semiconductor microelectronic wafers. A local planarization of the microchip operates chemically and mechanically to smooth surfaces at a microscopic level up to about 10 μm. A global planarization of the microchip extends above about 10 μm and higher. The CMP planarization equipment is used to remove materials prior to a subsequent precision integrated circuit manufacturing step.

The CMP planarization process involves a polishing slurry composed of an oxidant, an abrasive, complexing agents, and other additives. The polishing slurry is used with a polishing pad to remove excess Cu from the wafer. Silicon, Cu, and various trace metals are removed from the silicon structure by polishing the wafer with a chemical/mechanical slurry. The chemical/mechanical slurry is introduced to the silicon wafer on a planarization table in conjunction with polishing pads. Oxidizing agents and etching solutions are introduced to control the removal of material. Deionized water rinses often are employed to remove debris from the wafer. Ultrapure water (UPW) from reverse osmosis (RO) and demineralized water also can be used in the semiconductor fabrication facility tool to rinse the silicon wafer.

The CMP planarization process introduces Cu into the process water. Governmental regulatory agencies are writing regulations for the discharge of wastewater from CMP planarization processes as stringently as the wastewater from an electroplating process, even though CMP planarization is not an electroplating process.

The Cu ions in solution in the wastewater are desirably removed from the byproduct polishing slurry for acceptable wastewater disposal.

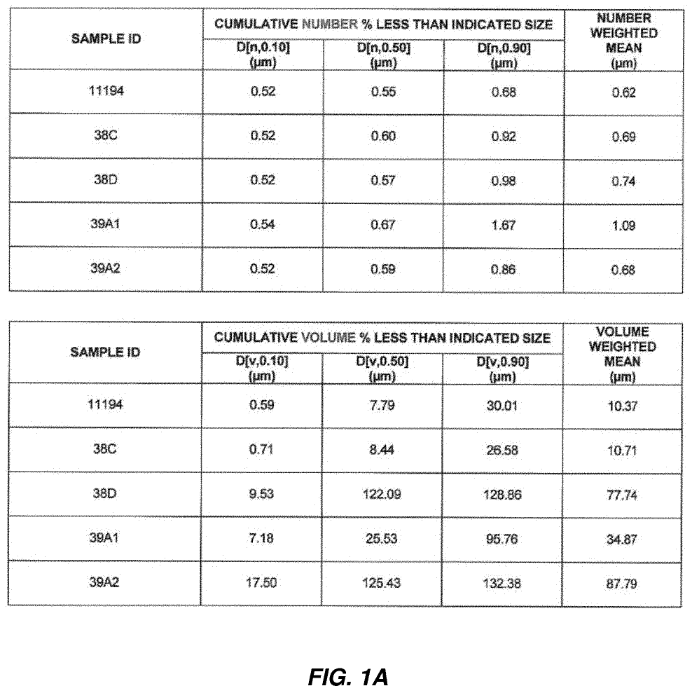

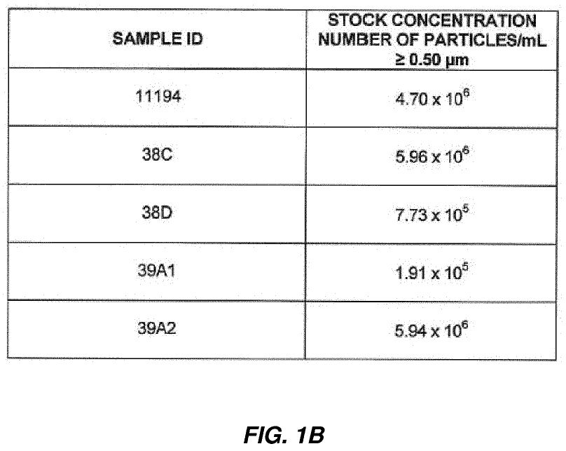

The CMP planarization of the microchip produces a byproduct “grinding” (polishing) slurry wastewater which contains Cu ions at a level of about 1-100 mg/l. The byproduct polishing slurry wastewater from the planarization of the microchip also contains abrasive material solids, for example, silica, alumina, and/or one or more other metal oxides, sized at about 0.01-1.0 μm in diameter at a level of about 500-2000 mg/l (500-2000 ppm). FIGS. 1A and 1B illustrates observed particle sizes and concentrations of particles of abrasive material in samples of waste slurry from a Cu CMP process. Sample 11194 was from a waste Cu polishing slurry stream after it was pH adjusted to 3.27 in a customer's system. Sample 38C was from a waste Cu polishing slurry stream collected prior to the customer's acidification step which was acidified in a testing lab to a pH of 4 with sulfuric acid. Sample 38D was from a waste Cu polishing slurry stream collected prior to the customer's acidification step which was acidified in the testing lab to a pH of 3 with sulfuric acid. Sample 39A1 was a sample of a waste Cu polishing slurry stream which was spiked in the testing lab with virgin slurry (3.35 mL/L) to simulate a higher solids condition. The pH of this sample after spiking with the virgin slurry was 7.0. Sample 39A2 was a sample of a waste Cu polishing slurry stream which was also spiked in the testing lab with virgin slurry (3.35 mL/L) to simulate a higher solids condition. The pH of this sample was adjusted to a pH of 3 with sulfuric acid. As can be seen from the table of FIG. 1, for each of the samples not spiked with virgin slurry, the number weighted mean particle size was less than 0.75 μm.

An oxidizer of hydrogen peroxide (H₂O₂) typically is used to help dissolve the Cu from the microchip during a CMP process. Accordingly, hydrogen peroxide (H₂O₂) at a level of about 300 ppm and higher also can be present in the byproduct polishing slurry wastewater.

A chelating agent such as citric acid or ammonia also can be present in the byproduct polishing slurry to facilitate keeping the Cu in solution.

A CMP slurry wastewater will discharge from some CMP tools at a flow rate of approximately 10 gpm, including rinse streams. This CMP slurry wastewater may contain dissolved Cu at a concentration of about 1-100 mg/l.

Fabrication facilities operating multiple tools will typically generate a sufficient quantity of Cu to be an environmental concern when discharged to the fabrication facility's outfall. A treatment program is desired to control the discharge of Cu present in the Cu CMP wastewater prior to introduction to the fabrication facility's wastewater treatment system.

A wastewater treatment system at a semiconductor fabrication facility often features pH neutralization and fluoride treatment. An “end-of-pipe” treatment system typically does not contain equipment for removal of heavy metals such as Cu. An apparatus and method for providing a point source treatment for Cu removal would resolve a need to install a costly end-of-pipe Cu treatment system.

Considering equipment logistics as well as waste solution characteristics, a point source Cu treatment unit is desired which is compact and which can satisfy the discharge requirements of a single Cu CMP tool or a cluster of Cu CMP tools.

Ion exchange technology is effective for concentrating and removing low levels of contaminants from large quantities of water. Ion exchange also has been employed effectively in wastewater treatment for removal of specific contaminants. For ion exchange to remove specific contaminants from wastewater economically, it is often important to utilize a selective resin or create an ionic selectivity for the specific ion that must be removed. Many ion exchange resin manufacturers developed selective resins during the 1980's. These ion exchange resins received wide acceptance because of their high capacity and high selectivity over conventional cation and anion resins for certain ions.

Cation selective resins have demonstrated their ability to remove transition metals from solutions containing complexing agents such as gluconates, citrates, tartrates, and ammonia, and some weak chelating compounds. These selective resins are called chelating resins, whereby the ion exchange sites grab onto and attach the transition metal. The chelating resin breaks the chemical bond between the complexing agent or a weaker chelating chemical.

The ion exchange resin is used to pull the Cu ions out of solution.

Copper slurry-containing wastewater may be treated with ion exchange to remove dissolved Cu. Normally the slurry passes through the ion exchange column without plugging the column. Recently however, new Cu CMP slurries are being used that have a smaller abrasive particle size than previously utilized Cu CMP slurries. The abrasive particle size distribution and concentration in the waste stream from CMP tools utilizing this new slurry is illustrated in FIGS. 1A and 1B described above. Waste streams from CMP tools utilizing examples of this new type of slurry have been observed to plug ion exchange systems as it passes through. Without being bound to a particular theory, it is believed that when the pH is dropped (to ˜3) prior to passing through the ion exchange system, the abrasive particles are growing by sticking together and causing plugging. The pH is typically lowered to get better Cu removal though the ion exchange system.

In one embodiment, a system and method are proposed to enable ion exchange treatment of a Cu-containing slurry comprising an ultrafilter and a thickening tank. Slurry Cu waste enters the ultrafilter system. In some embodiments, the ultrafilter system is operated as follows: 32 minutes in filtration mode, 2 minutes in back-wash mode. During the backwash mode, the filtrate may be processed back through the ultrafilter system at twice the rate of the forward flow rate. In some embodiments, the backwash itself lasts about 0.6 minutes. During the remaining 1.4 minutes, there is not forward or back flow through the ultrafilter system. During the backwash cycle, any solids which were removed by the ultrafilter system are flushed from the ultrafilter system. The backwash is directed to a thickening tank where the solids are allowed to settle. Settling of the solids may occur within a matter of seconds. The thickener supernatant (overflow) is mostly solids-free and may be directed back through the ultrafilter. The solids can be slowly bled to the effluent of the ion exchange system. While these solids still contain some Cu (for example, about 15 mg/L), the volume is reduced enough due to settling that they do not cause a significant increase in Cu in the combined ion exchange effluent/slurry solids discharge. If one assumes 0.1 mg/L of Cu in the ion exchange effluent, then the Cu level after blending the settled slurry solids with the ion exchange effluent would be 0.145 mg/L, still well below the 0.5 mg/L discharge target used in many jurisdictions.

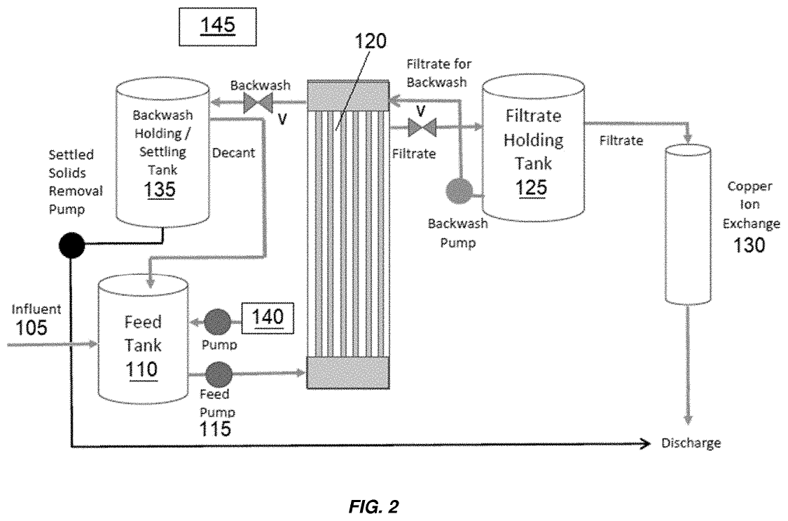

Referring to FIG. 2, the operation of the system is as follows:

An influent Cu-containing CMP slurry waste stream 105 is introduced into a feed tank 110. The CMP slurry waste stream 105 may have been pre-treated by pH adjustment to have a pH of about 3 before being introduced into the feed tank 110. Additionally or alternatively, the CMP slurry waste stream 105 may be pH adjusted in the feed tank 110 to a desired pH, for example, about 3 by introduction of a pH adjustment agent from a source of pH adjustment agent 140 (for example, sulfuric acid of sodium hydroxide) into the feed tank 110. During forward flow operation the Cu slurry waste flows from the feed tank 110 through the feed pump 115 and into the ultrafilter module 120. The Cu slurry waste is filtered through a membrane of the ultrafilter module 120 to produce a solid-lean filtrate. In some embodiments, the membrane of the ultrafilter module 120 is a polyethersulfone membrane with a pore size of 0.02 μm. The filtrate from the ultrafilter 120 is directed to a filtrate holding tank 125, from which it is pumped through the Cu ion exchange system 130. The Cu ion exchange system 130 may utilize resin such as LEWATIT® TP207 weakly acidic, macroporous ion exchange resin with chelating iminodiacetate groups (Sybron Chemicals Inc., a LANXESS Company, Birmingham, N.J.) or other resins and/or system components as disclosed in U.S. Pat. No. 7,488,423, incorporated herein by reference, and may be operated as disclosed in U.S. Pat. No. 7,488,423.

At set intervals (for example, every 32 minutes), the ultrafilter is backwashed using filtrate from the filtrate holding tank 125. The backwash, which contains slurry solids which were removed in the ultrafilter 120, is directed to the backwash holding tank 135. The backwash holding tank 135 operates much like a sludge thickener. As solids are collected, they are allowed to settle. The resultant supernatant is directed back to the feed tank 110. The supernatant is sent to the feed tank 110 instead of to the ion exchange system 130 because it may contain some residual solids.

The solids in the backwash holding tank 135 settle. The thickened/settled solids are then pumped to the effluent of the ion exchange system at a controlled rate. Here they are recombined with the now Cu-free (or essentially Cu-free, for example, having 0.1 mg/L dissolved Cu or less) effluent from the ion exchange system 130 and discharged. The solids will still contain some interstitial Cu, however, because their volume has been significantly reduced the Cu in the combined discharge is insignificant and the combined discharge may be discharged to the environment in many jurisdictions.

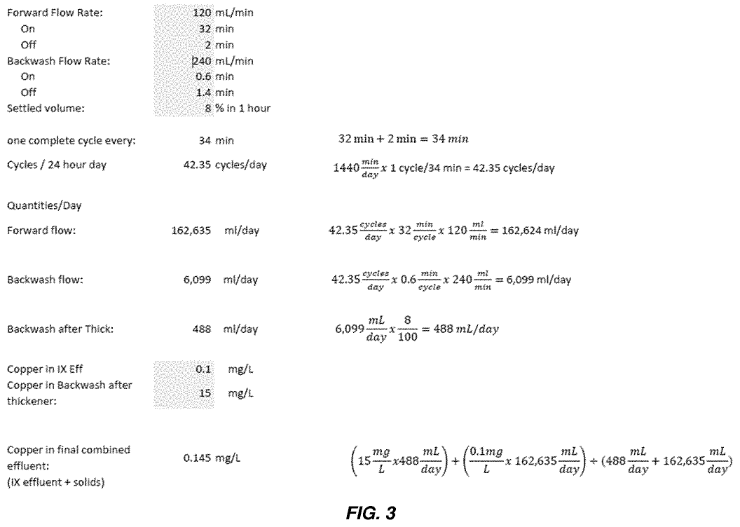

The solids are concentrated in the backwash holding tank 135 since they still contain interstitial Cu. Calculations show that the overall Cu level in the ion exchange system discharge is only slightly increased when the solids are reintroduced. Calculations for one example system are shown in FIG. 3 and indicate a total concentration of Cu of 0.145 mg/L in the final combined discharge from the system when fed with a waste stream including 15 mg/L of Cu—the concentration of Cu in the final combined discharge being less than 1% of the initial concentration in the waste stream.

The system may include a computerized controller 145 that controls the different valves V, pumps, and source of pH adjustment agent 140 of the system to perform embodiments of the method disclosed herein. Connections between the controller 145 and the valves, pumps, and source of pH adjustment agent are not shown for ease of illustration.

### Example—Ultrafiltration Tests

### Sample Description

Several Cu CMP slurry samples were received and evaluated. The list below details the samples (volume and label).

| Sample # | Volume | | Label |
|---|---|---|---|
| 11190 | 2 × 1 | L | D1X SCW Slurry Sample |
| 11193 | 1 × 55 | gal | Influent |
| 11245 | 1 × 55 | gal | D1X SCW Influent, pH ~9.5 |
| 11244 | 1 × 2.5 | gal | D1X SCW Slurry Sample (PL8109) - 1A |
| 11245 | 1 × 2.5 | gal | D1X SCW Slurry Sample (PL8109) - 1B |
| 11246 | 1 × 2.5 | gal | D1X SCW Slurry Sample (Cu4545) - 2A |
| 11247 | 1 × 2.5 | gal | D1X SCW Slurry Sample (Cu4545) - 2B |

### Ultrafilter Description

An ultrafilter used for evaluating methods of treating the different test samples included a single multi-bore polyethersulphone tube with seven 9-mm channels.

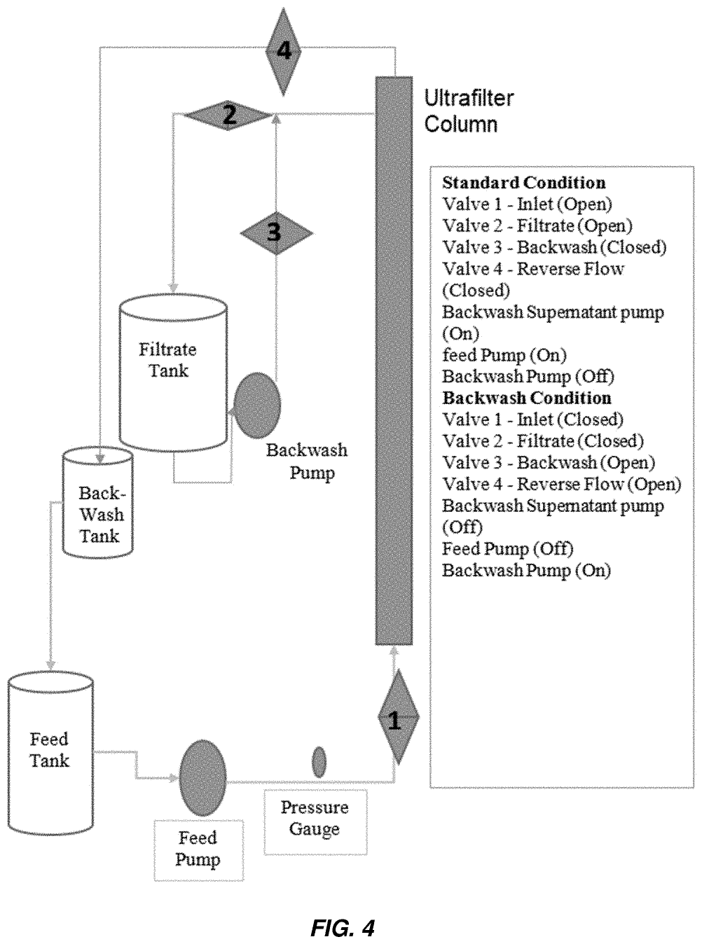

The following is a general description of the ultrafilter used for testing. A diagram of the experimental setup is shown in FIG. 4.

### Ultrafilter—Membrane

| | |
|---|---|
| Material of construction | polyethersulphone (PES) |
| Quantity | 1 |
| Surface area, total | 1.07 sq. ft. |
| Influent pump type | Positive Displacement |
| Backwash pump type | Positive Displacement |

### Operating Parameters

| | |
|---|---|
| Backpulse frequency (minutes) | 30-120 |
| Backpulse flow (GFD) | 135 |
| Influent Flow (GFD) | 35-40 |

### Modes of Operation

Several conditions of operation were examined including:
Standard Run: A deadhead type run where only a filtrate stream is generated. This is a 32-minute cycle with a 36-second backwash.
Elongated Run—A deadhead type run where the only a filtrate stream is generated. A 2-hour cycle with a deionized water rinse (to ensure no Cu is contained in the solids removed with the backwash) followed by a deionized water backwash.
Elongated run flow-through: A 2-hour cycle with a side stream recirculated from the concentrate back to the inlet at about 25% of the total flow. Once again, a deionized water rinse is used to remove Cu from the solids.

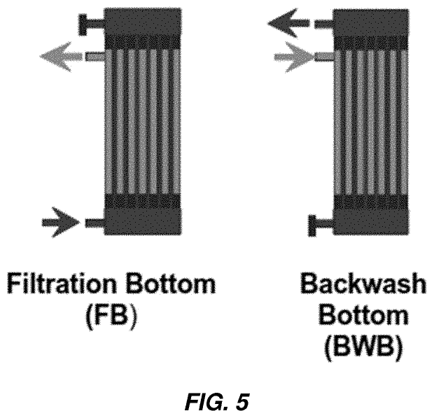

The direction of fluid flow into and out of the ultrafilter during filtration and backwash is illustrated in FIG. 5.

### Chemically Enhanced Backwash

Once the inlet pressure reached ˜12 PSI, the membrane was cleaned. The cleanings that took place during the ultrafiltration tests were chemically enhanced backwashes, or CEB for short. Typically, this involves taking a portion of the filtrate and pH adjusting to 12 with sodium hydroxide and/or pH 2 with sulfuric acid. These solutions are then used as the CEB solutions. There is a 5 to 60-minute soak period, then another backwash occurs using the regular filtrate and the run process resumes.

For this test, however, a slight modification was used due to the Cu present in the filtrate. The modified process is detailed below:
Run deionized water through the system for 10 minutes
Proceed with a sodium hydroxide solution backwash
Soak for 5-60 minutes
Rinse with deionized water
Proceed with sulfuric acid solution backwash
Soak for 5 minutes
Rinse with deionized water
Resume run (if a condition was to be changed, the base synthetic solution was run for a few hours to ensure the CEB was successful)

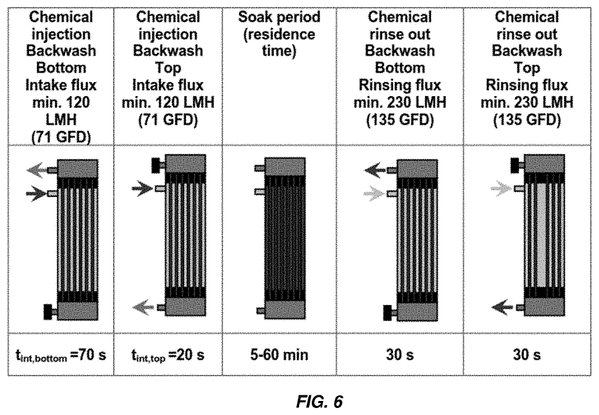

The steps in this chemically enhanced backwash are shown in FIG. 6.

### Operating Conditions

The first few conditions tested were for determination of viability for ultrafiltration use.

### Condition 1:

Base Solution: Sample #11225
Spike Solution: 3.35 mL/L slurry sample #11190
pH: As is—pH 6.96
Backwash frequency: 32 minutes
Flow: 43 GFD
Total Run Time: 4 hours

Condition 1 - As is pH

| | Inlet | | Turbidity | Turbidity | Copper | Copper |
|---|---|---|---|---|---|---|
| Time | Pressure | Flow | In | Out | In | Out |
| (minutes) | (PSI) | (GFD) | (NTU) | (NTU) | (mg/L) | (mg/L) |
| 0 | 0 | 42.6 | 8.4 | — | 11.16 | — |
| 30 | 0.6 | 44.1 | — | 0.00 | — | 11.14 |
| 60 | 0.8 | 42.6 | — | — | — | — |
| 90 | 0.8 | 42.6 | — | — | — | — |
| 120 | 1 | 44.1 | — | 0.00 | — | — |
| 150 | 1.1 | 42.6 | — | — | — | — |
| 180 | 1.2 | 42.6 | — | — | — | — |
| 240 | 1.2 | 44.1 | — | 0.00 | — | — |

### Condition 2:

Base Solution: Sample #11225
Spike Solution: 3.35 mL/L slurry sample #11190
pH: 3 (sulfuric acid used to drop the pH)
Backwash frequency: 32 minutes
Flow: 43 GFD
Total Run Time: 4 hours

Condition 2 - pH 3

| | Inlet | | Turbidity | Turbidity | Copper | Copper |
|---|---|---|---|---|---|---|
| Time | Pressure | Flow | In | Out | In | Out |
| (minutes) | (PSI) | (GFD) | (NTU) | (NTU) | (mg/L) | (mg/L) |
| 0 | 0.5 | 42.6 | 36.2 | — | 11.24 | — |
| 30 | 0.6 | 42.6 | — | 0.00 | — | 11.18 |
| 60 | 0.6 | 42.6 | — | — | — | — |
| 90 | 0.6 | 42.6 | — | — | — | — |
| 120 | 0.6 | 43.0 | — | 0.00 | — | — |
| 210 | 0.6 | 43.8 | — | — | — | — |
| 240 | 0.6 | 43.8 | — | 0.00 | — | — |

### Condition 3:

Purpose of test: Determine if UF is a viable alternative to microfiltration
Base Solution: Deionized water spiked with copper sulfate and peroxide initially, then used synthetic sample
Spike Solution: 3.35 mL/L each slurry samples #11244 and #11245
pH: 3 (required 14 mg/L sulfuric acid)
Backwash frequency: 32 minutes
Flow: 38 GFD
Total Run Time: 10 hours

Condition 3 - MF Feed pH 3

| | Time | Inlet Pressure | Flow |
|---|---|---|---|
| Run ID | (minutes) | (PSI) | GFD |
| 1 | Start | 0.2 | 38 |
| 1 | 10 | 0.2 | 38 |
| 1 | 20 | 0.25 | 38 |
| 1 | 30 | 0.3 | 37.7 |
| 1 | 40 | 0.3 | 37.7 |
| 1 | 50 | 0.35 | 38.0 |
| 1 | 60 | 0.4 | |
| 1 | 70 | 0.5 | |
| 1 | 80 | 0.6 | |
| 1 | 90 | 0.7 | 38.4 |
| 1 | 100 | 0.8 | 38.4 |
| 1 | 110 | 0.11 | |
| 1 | 120 | 1.4 | 38.4 |

Copper rinse, then backwash, use synthetic sample

| | | | |
|---|---|---|---|
| 2 | Start | 0.5 | 38.4 |
| 2 | 10 | 0.55 | |
| 2 | 20 | 0.65 | |
| 2 | 30 | 8 | 38.4 |
| 2 | 40 | 0.95 | |
| 2 | 50 | 1.1 | |
| 2 | 60 | 1.3 | 38.0 |
| 2 | 70 | 1.4 | |
| 2 | 80 | 1.6 | |
| 2 | 90 | 1.9 | 38.7 |
| 2 | 100 | 2.2 | |
| 2 | 110 | 3 | |
| 2 | 120 | 3.5 | 38.0 |

Backwash

| | | | |
|---|---|---|---|
| 3 | Start | 1.1 | 38.4 |
| 3 | 10 | 1.3 | |
| 3 | 20 | 1.4 | |
| 3 | 30 | 1.7 | 38.0 |
| 3 | 40 | 2 | |
| 3 | 50 | 2.6 | |
| 3 | 60 | 3.1 | 38.7 |
| 3 | 70 | 3.5 | |
| 3 | 80 | 4 | |
| 3 | 90 | 4.4 | 38.0 |
| 3 | 100 | 5 | |
| 3 | 110 | 5.5 | |
| 3 | 120 | 5.9 | 38.0 |

Backwash

| | | | |
|---|---|---|---|
| 4 | Start | 2.4 | 39.1 |
| 4 | 10 | 2.9 | |
| 4 | 20 | 3.3 | |
| 4 | 30 | 3.7 | 39.0 |
| 4 | 40 | 4.4 | |
| 4 | 50 | 5.1 | |
| 4 | 60 | 6 | 38.7 |
| 4 | 70 | 7 | |
| 4 | 80 | 8 | |
| 4 | 90 | 9.1 | 38.7 |
| 4 | 100 | 10.1 | |
| 4 | 110 | 11.25 | |
| 4 | 120 | 12 | 38.4 |

CEB—NaOH/60-minute soak/H₂SO₄/5-minute soak

| | | | |
|---|---|---|---|
| 5 | Start | 0.2 | 38.4 |
| 5 | 10 | 0.4 | |
| 5 | 20 | 0.5 | |
| 5 | 30 | 0.5 | 38.4 |
| 5 | 40 | 0.6 | |
| 5 | 50 | 0.7 | |
| 5 | 60 | 0.9 | 38.7 |
| 5 | 70 | 1 | |
| 5 | 80 | 1.1 | |
| 5 | 90 | 1.2 | 38.45 |
| 5 | 100 | 1.3 | |
| 5 | 110 | 1.4 | |
| 5 | 120 | 1.5 | 38.4 |

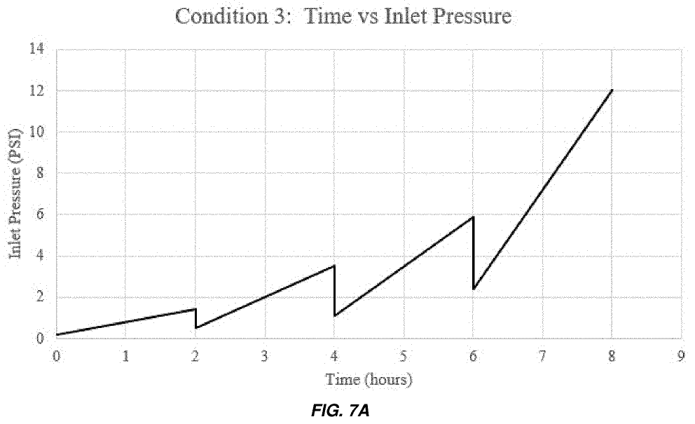

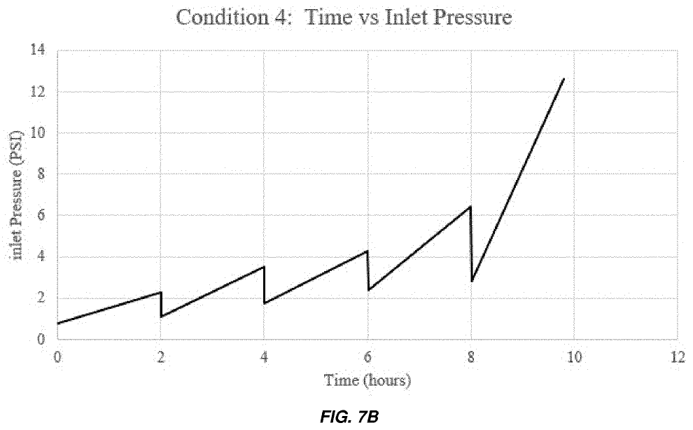

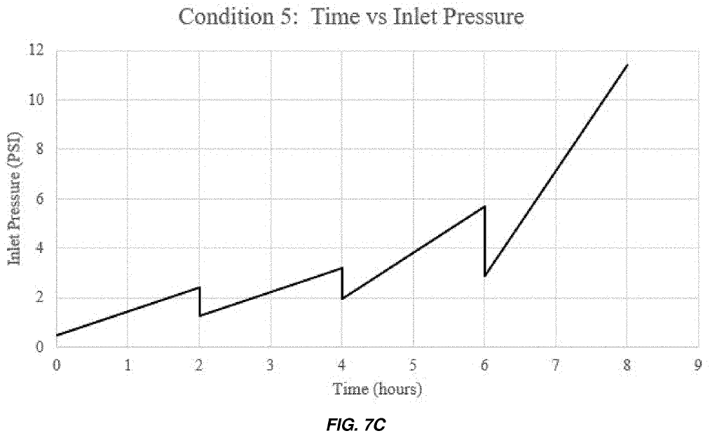

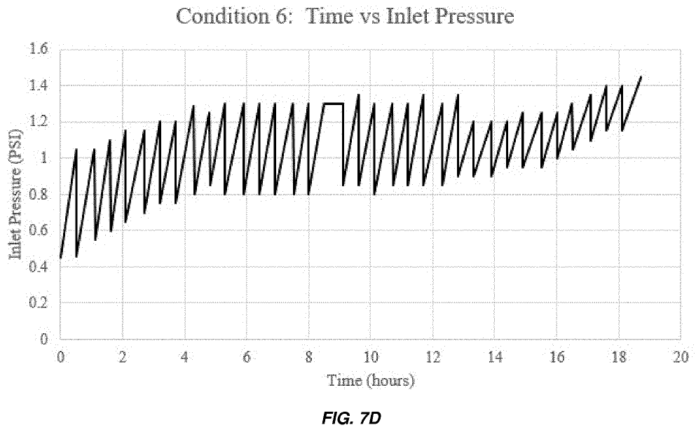

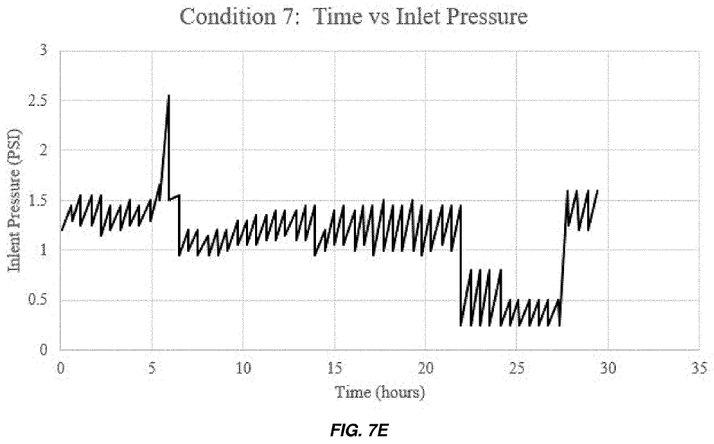

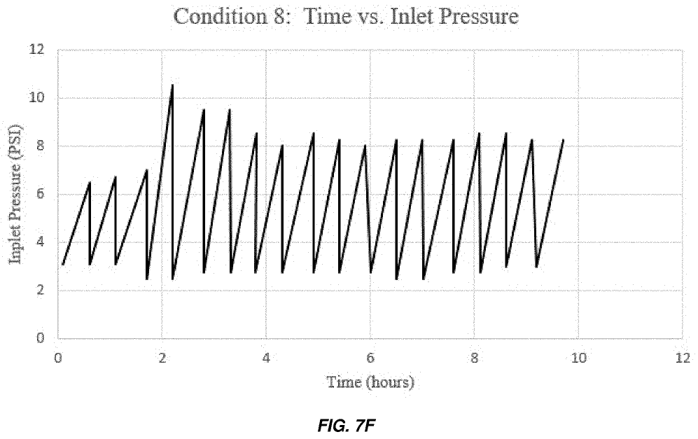

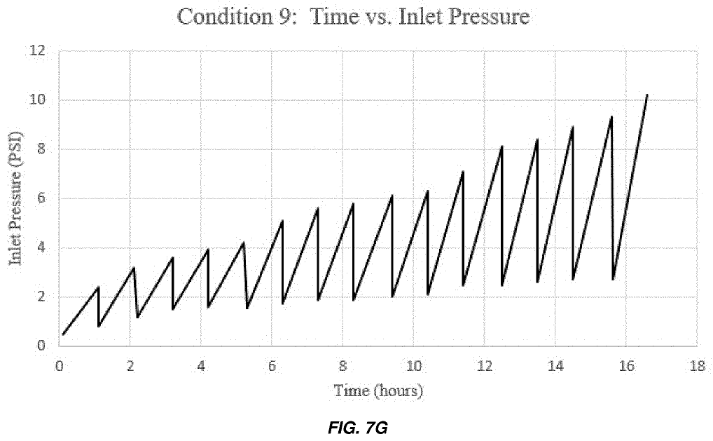

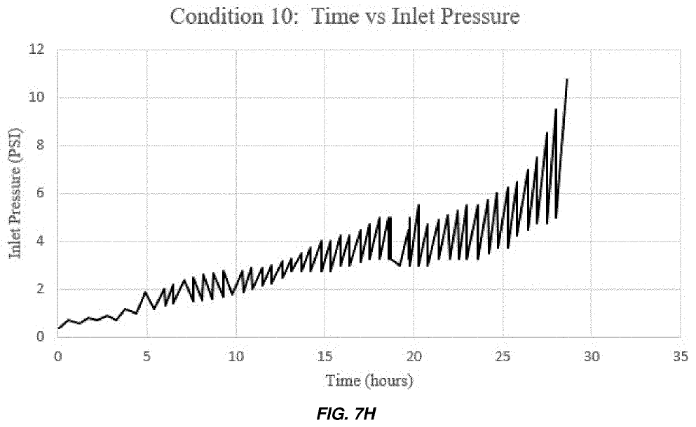

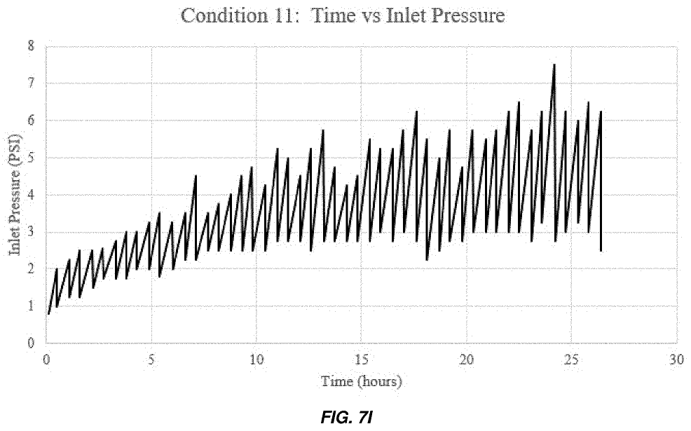

A chart of time versus inlet pressure for the ultrafilter operated under condition 3 is illustrated in FIG. 7A. The inlet pressure increased for each subsequent filtration run, reaching a high of 12 psi after eight hours/four filtration and three backwash operations.

### Condition 4:

Purpose of test: Extend the run time between backwashes
Base Solution: Deionized water with copper and peroxide added
Spike Solution: 3.35 mL/L each slurry samples #11244 and #11245
pH: 6
Backwash frequency: 120 minutes
Flow: 38 GFD
Total Run Time: 9 hours 40 minutes

Condition 4 - Synthetic Solution pH 6

| | Time | Inlet Pressure | Flow |
|---|---|---|---|
| Run ID | (minutes) | (PSI) | (mL/min) |
| 1 | Start | 0.8 | 38.4 |
| 1 | 10 | 0.9 | |
| 1 | 20 | 1 | |
| 1 | 30 | 1.15 | 38.4 |
| 1 | 40 | 1.3 | |
| 1 | 50 | 1.35 | |
| 1 | 60 | 1.45 | 38.0 |
| 1 | 70 | 1.6 | |
| 1 | 80 | 1.75 | |
| 1 | 90 | 1.85 | |
| 1 | 100 | 2 | 38.4 |
| 1 | 110 | 2.15 | |
| 1 | 120 | 2.3 | 38.4 |

Copper rinse-out, then backwash

| | | | |
|---|---|---|---|
| 2 | Start | 1.1 | 38.4 |
| 2 | 10 | 1.15 | |
| 2 | 20 | 1.25 | |
| 2 | 30 | 1.35 | 39.1 |
| 2 | 40 | 1.65 | |
| 2 | 50 | 1.85 | |
| 2 | 60 | 2 | |
| 2 | 70 | 2.15 | |
| 2 | 80 | 2.35 | |
| 2 | 90 | 2.6 | 38.4 |
| 2 | 100 | 2.9 | |
| 2 | 110 | 3.2 | |
| 2 | 120 | 3.5 | |

Backwash

| | | | |
|---|---|---|---|
| 3 | Start | 1.75 | 38.4 |
| 3 | 10 | 1.85 | |
| 3 | 20 | 2 | |
| 3 | 30 | 2.15 | 38.4 |
| 3 | 40 | 2.35 | |
| 3 | 50 | 2.5 | |
| 3 | 60 | 2.65 | |
| 3 | 70 | 2.85 | |
| 3 | 80 | 3.05 | |
| 3 | 90 | 3.25 | 38.4 |
| 3 | 100 | 3.6 | |
| 3 | 110 | 3.9 | |
| 3 | 120 | 4.3 | 38.4 |

Backwash

| | | | |
|---|---|---|---|
| 4 | Start | 2.4 | 39.1 |
| 4 | 10 | 2.5 | |
| 4 | 20 | 2.65 | |
| 4 | 30 | 2.8 | 38.4 |
| 4 | 40 | 3 | |
| 4 | 50 | 3.25 | |
| 4 | 60 | 3.5 | |
| 4 | 70 | 3.85 | |
| 4 | 80 | 4.15 | |
| 4 | 90 | 4.5 | 39.1 |
| 4 | 100 | 4.9 | |
| 4 | 110 | 5.5 | |
| 4 | 120 | 6.4 | 39.1 |

Backwash

| | | | |
|---|---|---|---|
| 5 | Start | 2.85 | 39.1 |
| 5 | 10 | 3.25 | |
| 5 | 20 | 3.65 | |
| 5 | 30 | 4.55 | 38.4 |
| 5 | 40 | 5.6 | |
| 5 | 50 | 6.7 | |
| 5 | 60 | 7.8 | |
| 5 | 70 | 9.1 | |
| 5 | 80 | 10.25 | |
| 5 | 90 | 11.4 | 39.1 |
| 5 | 100 | 12.6 | |

CEB—NaOH/5-minute soak/H₂SO₄/5-minute soak

A chart of time versus inlet pressure for the ultrafilter operated under condition 4 is illustrated in FIG. 7B. The inlet pressure increased for each subsequent filtration run, reaching a high of over 12 psi after about 10 hours/five filtration and four backwash operations.

### Condition 5:

Purpose of test: Determine if flow through mode elongates run
Base Solution: Deionized water with copper and peroxide added
Spike Solution: 3.35 mL/L each of slurry samples #11244 and #11245
pH: 6
Backwash frequency: 120 minutes
Flow: 38 GFD
Total Run Time: 8 hours

Condition 5 - pH 6 with Recycle

| | Time | Inlet Pressure | |
|---|---|---|---|
| Run ID | (minutes) | (PSI) | GFD |
| 1 | Start | 0.6 | 39.1 |
| 1 | 10 | 0.7 | |
| 1 | 20 | 1 | |
| 1 | 30 | 1.05 | 39.1 |
| 1 | 40 | 1.25 | |
| 1 | 50 | 1.4 | |
| 1 | 60 | 1.5 | 38.4 |
| 1 | 70 | 1.65 | |
| 1 | 80 | 1.8 | |
| 1 | 90 | 1.9 | |
| 1 | 100 | 2.05 | 37.7 |
| 1 | 110 | 2.25 | |
| 1 | 120 | 2.4 | 39.1 |

Backwash

| | | | |
|---|---|---|---|
| 2 | Start | 1.25 | 39.1 |
| 2 | 10 | 1.35 | |
| 2 | 20 | 1.55 | |
| 2 | 30 | 1.75 | 38.0 |
| 2 | 40 | 1.85 | |
| 2 | 50 | 2 | |
| 2 | 60 | 2.1 | |
| 2 | 70 | 2.25 | |
| 2 | 80 | 2.45 | |
| 2 | 90 | 2.65 | 39.1 |
| 2 | 100 | 2.85 | |
| 2 | 110 | 3 | |
| 2 | 120 | 3.2 | 39.1 |

Backwash

| | | | |
|---|---|---|---|
| 3 | Start | 1.95 | 39.1 |
| 3 | 10 | 2.15 | |
| 3 | 20 | 2.3 | |
| 3 | 30 | 2.55 | |
| 3 | 40 | 2.7 | 38.4 |
| 3 | 50 | 2.85 | |
| 3 | 60 | 2.95 | |
| 3 | 70 | 3.25 | |
| 3 | 80 | 3.5 | |
| 3 | 90 | 3.7 | |
| 3 | 100 | 4.2 | 39.1 |
| 3 | 110 | 4.9 | |
| 3 | 120 | 5.7 | 39.1 |

Backwash

| | | | |
|---|---|---|---|
| 4 | Start | 2.9 | 39.1 |
| 4 | 10 | 3.5 | |
| 4 | 20 | 4.2 | |
| 4 | 30 | 4.7 | 39.1 |
| 4 | 40 | 5.3 | |
| 4 | 50 | 5.9 | |
| 4 | 60 | 6.3 | |
| 4 | 70 | 7.1 | |
| 4 | 80 | 7.9 | 38.4 |
| 4 | 90 | 8.6 | |
| 4 | 100 | 9.5 | |
| 4 | 110 | 10.4 | |
| 4 | 120 | 11.4 | 38.0 |

CEB—NaOH/5-minute soak/H₂SO₄/5-minute soak

A chart of time versus inlet pressure for the ultrafilter operated under condition 5 is illustrated in FIG. 7C. The inlet pressure increased for each subsequent filtration run, reaching a high of close to 12 psi after about eight hours/four filtration and three backwash operations.

### Condition 6:

Purpose of test: Standard Run Mode
Base Solution: Deionized water with copper and peroxide added
Spike Solution: 3.35 mL/L each of slurry samples #11244 and #11245
pH: 6
Backwash frequency: 32 minutes
Flow: 38 GFD

Condition 6 - Standard Run Mode Synthetic Sample

| Run Time | Inlet Pressure | Flow |
|---|---|---|
| (hours) | (PSI) | (GFD) |
| 0.01 | 0.45 | 38 |
| 0.5 | 1.05 | — |
| 0.51 | 0.456 | — |
| 1.1 | 1.05 | — |
| 1.11 | 0.55 | — |
| 1.6 | 1.1 | — |
| 1.61 | 0.6 | — |
| 2.1 | 1.15 | — |
| 2.11 | 0.65 | — |
| 2.7 | 1.15 | — |
| 2.71 | 0.7 | — |
| 3.2 | 1.2 | — |
| 3.21 | 0.75 | — |
| 3.7 | 1.2 | — |
| 3.71 | 0.75 | — |
| 4.3 | 1.285 | — |
| 4.31 | 0.8 | — |
| 4.8 | 1.25 | — |
| 4.81 | 0.85 | — |
| 5.3 | 1.3 | — |
| 5.31 | 0.8 | — |
| 5.9 | 1.3 | — |
| 5.91 | 0.8 | — |
| 6.4 | 1.3 | — |
| 6.41 | 0.8 | — |
| 6.9 | 1.3 | — |
| 6.91 | 0.8 | — |
| 7.5 | 1.3 | — |
| 7.51 | 0.8 | — |
| 8.0 | 1.3 | — |
| 8.01 | 0.8 | — |
| 8.5 | 1.3 | — |
| 9.1 | 1.3 | — |
| 9.11 | 0.85 | — |
| 9.6 | 1.35 | — |
| 9.61 | 0.85 | — |
| 10.1 | 1.3 | 40 |
| 10.11 | 0.8 | — |
| 10.7 | 1.3 | — |
| 10.71 | 0.85 | — |
| 11.2 | 1.3 | — |
| 11.21 | 0.85 | — |
| 11.7 | 1.35 | — |
| 11.71 | 0.85 | — |
| 12.3 | 1.3 | — |
| 12.31 | 0.85 | 38 |
| 12.8 | 1.35 | — |
| 12.81 | 0.9 | — |
| 13.3 | 1.2 | — |
| 13.31 | 0.9 | — |
| 13.9 | 1.2 | — |
| 13.91 | 0.9 | — |
| 14.4 | 1.2 | — |
| 14.41 | 0.95 | — |
| 14.9 | 1.25 | — |
| 14.91 | 0.95 | — |
| 15.5 | 1.25 | — |
| 15.51 | 0.95 | — |
| 16.0 | 1.25 | — |
| 16.01 | 1 | — |
| 16.5 | 1.3 | — |
| 16.51 | 1.05 | — |
| 17.1 | 1.35 | — |
| 17.11 | 1.1 | — |
| 17.6 | 1.4 | — |
| 17.61 | 1.15 | — |
| 18.1 | 1.4 | — |
| 18.11 | 1.15 | — |
| 18.7 | 1.45 | 39 |

A chart of time versus inlet pressure for the ultrafilter operated under condition 6 is illustrated in FIG. 7D. The inlet pressure initially increased for each subsequent filtration run, remained steady at about 1.2-1.3 psi for runs between four and 16 hours of running, and then began to increase with subsequent runs reaching a high of just above 1.4 psi after about 18 hours/34 filtration and 33 backwash operations.

### Condition 7:

Purpose of test: Standard Run Mode with backwash supernatant decanted to feed tank
Base Solution: Deionized water with copper and peroxide added
Spike Solution: 3.35 mL/L each of slurry samples #11244 and #11245
pH: 6
Backwash frequency: 32 minutes
Flow: 40 GFD

Condition 7 - Standard Run Mode Backwash Supernatant Recycled

| Run Time | Inlet Pressure | Flow |
|---|---|---|
| (hours) | (PSI) | (GFD) |
| 0.1 | 1.2 | 40 |
| 0.6 | 1.45 | — |
| 0.61 | 1.3 | — |
| 1.1 | 1.55 | — |
| 1.11 | 1.25 | — |
| 1.7 | 1.55 | — |
| 1.71 | 1.25 | — |
| 2.2 | 1.55 | — |
| 2.21 | 1.15 | — |
| 2.7 | 1.45 | — |
| 2.71 | 1.2 | — |
| 3.3 | 1.45 | — |
| 3.31 | 1.2 | — |
| 3.8 | 1.5 | — |
| 3.81 | 1.25 | — |
| 4.3 | 1.45 | — |
| 4.31 | 1.25 | — |
| 4.9 | 1.5 | — |
| 4.91 | 1.3 | — |
| 5.4 | 1.65 | — |
| 5.41 | 1.5 | — |
| 5.9 | 2.55 | — |
| 5.91 | 1.5 | — |
| 6.5 | 1.55 | — |
| 6.51 | 0.95 | — |
| 7.0 | 1.2 | — |
| 7.01 | 1 | — |
| 7.5 | 1.2 | 40 |
| 7.51 | 0.95 | — |
| 8.1 | 1.15 | — |
| 8.11 | 0.95 | — |
| 8.6 | 1.2 | — |
| 8.61 | 0.95 | — |
| 9.1 | 1.2 | — |
| 9.11 | 1 | — |
| 9.7 | 1.3 | — |
| 9.71 | 1.05 | — |
| 10.2 | 1.3 | 40 |
| 10.21 | 1.05 | — |
| 10.7 | 1.35 | — |
| 10.71 | 1.05 | — |
| 11.3 | 1.35 | — |
| 11.31 | 1.1 | — |
| 11.8 | 1.4 | — |
| 11.81 | 1.1 | — |
| 12.3 | 1.4 | — |
| 12.31 | 1.15 | — |
| 12.9 | 1.4 | — |
| 12.91 | 1.1 | — |
| 13.4 | 1.45 | — |
| 13.41 | 1.1 | 40.5 |
| 13.9 | 1.45 | — |
| 13.91 | 0.95 | — |
| 14.5 | 1.2 | — |
| 14.51 | 1 | — |
| 15.0 | 1.4 | — |
| 15.01 | 1.05 | — |
| 15.5 | 1.45 | — |
| 15.51 | 1.05 | — |
| 16.1 | 1.4 | — |
| 16.11 | 1 | — |
| 16.6 | 1.45 | — |
| 16.61 | 1.05 | — |
| 17.1 | 1.45 | — |
| 17.11 | 0.95 | — |
| 17.7 | 1.5 | 41 |
| 17.71 | 1 | — |
| 18.2 | 1.45 | — |
| 18.21 | 1 | — |
| 18.7 | 1.45 | — |
| 18.71 | 1 | — |
| 19.3 | 1.5 | — |
| 19.31 | 1 | — |
| 19.8 | 1.45 | — |
| 19.81 | 0.95 | — |
| 20.3 | 1.4 | — |
| 20.31 | 1 | — |
| 20.9 | 1.45 | — |
| 20.91 | 1.05 | — |
| 21.4 | 1.45 | — |
| 21.41 | 1 | — |
| 21.9 | 1.45 | — |
| 21.91 | 0.25 | — |
| 22.5 | 0.8 | — |
| 22.51 | 0.25 | — |
| 23.0 | 0.8 | — |
| 23.01 | 0.25 | — |
| 23.5 | 0.8 | 40 |
| 23.51 | 0.25 | — |
| 24.1 | 0.8 | — |
| 24.11 | 0.25 | — |
| 24.6 | 0.5 | — |
| 24.61 | 0.25 | — |
| 25.1 | 0.5 | — |
| 25.11 | 0.25 | — |
| 25.7 | 0.5 | — |
| 25.71 | 0.25 | — |
| 26.2 | 0.5 | — |
| 26.21 | 0.25 | — |
| 26.7 | 0.5 | — |
| 26.71 | 0.25 | — |
| 27.3 | 0.5 | — |
| 27.31 | 0.25 | — |
| 27.8 | 1.6 | — |
| 27.81 | 1.25 | — |
| 28.3 | 1.6 | — |
| 28.4 | 1.2 | — |
| 28.9 | 1.6 | — |
| 28.91 | 1.2 | — |
| 29.4 | 1.6 | 40.5 |

CEB—NaOH/5-minute soak/H2SO4/5-minute soak
Run to verify CEB Effectiveness

| | | |
|---|---|---|
| 0.1 | 0.4 | — |
| 0.5 | 0.6 | — |
| 0.51 | 0.45 | — |
| 1.1 | 0.75 | — |
| 1.11 | 0.45 | — |
| 1.6 | 0.8 | — |
| 1.61 | 0.5 | 41 |
| 2.1 | 0.8 | — |
| 2.11 | 0.5 | — |

A chart of time versus inlet pressure for the ultrafilter operated under condition 7 is illustrated in FIG. 7E. In this chart, the data from 21.91 hours-27.31 hours is invalid due to a gauge failure. The maximum inlet pressure at the end of each filtration run remained fairly steady at about 1.5 psi with a number of filtration runs reaching a lower maximum inlet pressure between seven and 13 hours of running.

### Condition 8:

Purpose of test: Determine if the reconstitution of all backwash solids increase inlet pressure or affect longevity of the run. Standard Run Mode with backwash supernatant decanted to the feed tank. Backwash solids were collected and added into the feed.
Base Solution: Deionized water with copper and peroxide added
Spike Solution: 3.35 mL/L each of slurry samples #11244 and #11245
pH: 6
Backwash frequency: 32 minutes
Flow: 40 GFD

Condition 8 - Standard Run Mode Recycled
Sample With Backwash Added to Feed

| Run Time | Inlet Pressure | Flow |
|---|---|---|
| (hours) | (PSI) | (GFD) |
| 0.1 | 3.1 | 40 |
| 0.6 | 6.5 | — |
| 0.61 | 3.1 | — |
| 1.1 | 6.7 | — |
| 1.11 | 3.1 | — |
| 1.7 | 7 | — |
| 1.71 | 2.5 | — |
| 2.2 | 10.5 | — |
| 2.21 | 2.5 | — |
| 2.8 | 9.5 | — |
| 2.81 | 2.75 | — |
| 3.3 | 9.5 | — |
| 3.31 | 2.75 | — |
| 3.81 | 8.5 | — |
| 3.8 | 2.75 | — |
| 4.3 | 8 | — |
| 4.31 | 2.75 | — |
| 4.9 | 8.5 | — |
| 4.91 | 2.75 | — |
| 5.4 | 8.25 | — |
| 5.41 | 2.75 | — |
| 5.9 | 8 | — |
| 6.0 | 2.75 | — |
| 6.5 | 8.25 | — |
| 6.51 | 2.5 | — |
| 7.0 | 8.25 | — |
| 7.01 | 2.5 | — |
| 7.6 | 8.25 | 40 |
| 7.6 | 2.75 | — |
| 8.1 | 8.5 | — |
| 8.11 | 2.75 | — |
| 8.6 | 8.5 | — |
| 8.61 | 3 | — |
| 9.1 | 8.25 | — |
| 9.2 | 3 | — |
| 9.7 | 8.25 | — |

CEB—NaOH/5-minute soak/H₂SO₄/5-minute soak
Run to verify CEB Effectiveness

| | | |
|---|---|---|
| 0.1 | 0.2 | 40 |
| 0.6 | 0.7 | — |
| 0.61 | 0.25 | — |
| 1.2 | 0.8 | — |
| 1.21 | 0.25 | — |
| 1.7 | 0.85 | — |
| 1.71 | 0.25 | — |
| 2.2 | 0.85 | — |

A chart of time versus inlet pressure for the ultrafilter operated under condition 8 is illustrated in FIG. 7F. The maximum inlet pressure initially increased for subsequent filtration runs up to about 10 psi, but then decreased and remained fairly steady at about 8 psi for subsequent filtration runs.

### Condition 9:

Purpose of test: Determine if 1-hour run between backwashes is feasible.
Base Solution: Deionized water with copper and peroxide added
Spike Solution: 3.35 mL/L each of slurry samples #11244 and #11245
pH: 6
Backwash frequency: 60 minutes
Flow: 40 GFD

Condition 9 - Standard Run Mode 60 Minute Backwash

| Run Time | Inlet Pressure | Flow |
|---|---|---|
| (hours) | (PSI) | (GFD) |
| 0.1 | 0.5 | 41 |
| 1.1 | 2.4 | — |
| 1.11 | 0.8 | — |
| 2.1 | 3.2 | — |
| 2.2 | 1.2 | — |
| 3.2 | 3.6 | — |
| 3.21 | 1.5 | — |
| 4.2 | 3.9 | — |
| 4.21 | 1.6 | — |
| 5.2 | 4.2 | — |
| 5.3 | 1.55 | — |
| 6.3 | 5.1 | — |
| 6.31 | 1.75 | — |
| 7.3 | 5.6 | — |
| 7.31 | 1.9 | — |
| 8.3 | 5.8 | — |
| 8.31 | 1.9 | — |
| 9.4 | 6.1 | — |
| 9.41 | 2 | — |
| 10.4 | 6.3 | — |
| 10.41 | 2.1 | — |
| 11.4 | 7.1 | — |
| 11.41 | 2.5 | — |
| 12.5 | 8.1 | — |
| 12.51 | 2.5 | — |
| 13.5 | 8.4 | — |
| 13.51 | 2.6 | 40 |
| 14.5 | 8.9 | — |
| 14.51 | 2.7 | — |
| 15.6 | 9.3 | — |
| 15.61 | 2.7 | — |
| 16.6 | 10.2 | — |

CEB—NaOH/5-minute soak/H₂SO₄/5-minute soak

A chart of time versus inlet pressure for the ultrafilter operated under condition 9 is illustrated in FIG. 7G. The inlet pressure increased for each subsequent filtration run, reaching a high of over 10 psi after about 16 hours/16 filtration and 15 backwash operations.

### Condition 10:

Purpose of test: Repeat Standard Run Mode with backwash supernatant decanted to feed tank to determine the effect of bio-growth accumulation.
Base Solution: Deionized water with copper and peroxide added
Spike Solution: 3.35 mL/L each of slurry samples #11244 and #11245
pH: 6
Backwash frequency: 32 minutes
Flow: 40 GFD

Condition 10 - Standard Run Mode 32 Minute Backwash

| Run Time | Inlet Pressure | Flow |
|---|---|---|
| (hours) | (PSI) | (GFD) |
| 0.1 | 0.4 | 41 |
| 0.6 | 0.7 | — |
| 1.2 | 0.6 | — |
| 1.7 | 0.8 | — |
| 2.2 | 0.7 | — |
| 2.8 | 0.9 | — |
| 3.3 | 0.7 | — |
| 3.8 | 1.2 | — |
| 4.4 | 1 | — |
| 4.9 | 1.9 | — |
| 5.4 | 1.2 | — |
| 5.41 | 1.2 | — |
| 6.0 | 2 | — |
| 6.01 | 1.3 | — |
| 6.5 | 2.2 | — |
| 6.51 | 1.4 | — |
| 7.1 | 2.4 | — |
| 7.6 | 1.5 | — |
| 7.61 | 2.5 | — |
| 8.1 | 1.55 | — |
| 8.2 | 2.6 | — |
| 8.7 | 1.6 | — |
| 8.71 | 2.65 | — |
| 9.3 | 1.7 | — |
| 9.31 | 2.75 | — |
| 9.8 | 1.8 | 40 |
| 10.4 | 2.75 | — |
| 10.41 | 1.9 | — |
| 10.9 | 2.9 | — |
| 10.91 | 2 | — |
| 11.5 | 2.9 | — |
| 11.51 | 2.15 | — |
| 12.0 | 3 | — |
| 12.01 | 2.25 | — |
| 12.6 | 3.2 | — |
| 12.61 | 2.5 | — |
| 13.1 | 3.25 | — |
| 13.11 | 2.75 | — |
| 13.7 | 3.5 | — |
| 13.71 | 2.75 | — |
| 14.2 | 3.75 | — |
| 14.21 | 2.75 | — |
| 14.8 | 4 | — |
| 14.81 | 2.75 | — |
| 15.3 | 4 | — |
| 15.31 | 2.75 | 42 |
| 15.9 | 4.25 | — |
| 15.91 | 3 | — |
| 16.4 | 4.25 | — |
| 16.41 | 3 | — |
| 17.0 | 4.5 | — |
| 17.01 | 3.15 | — |
| 17.5 | 4.7 | 41 |
| 17.51 | 3.25 | — |
| 18.1 | 5 | — |
| 18.11 | 3.25 | — |
| 18.6 | 5 | — |
| 18.61 | 3.25 | — |
| 18.7 | 5 | — |
| 18.71 | 3.25 | — |
| 19.21 | 3.00 | — |
| 19.7 | 4.50 | — |
| 19.71 | 3.25 | — |
| 19.8 | 5.00 | — |
| 19.81 | 3.00 | — |
| 20.3 | 5.50 | — |
| 20.31 | 3.00 | — |
| 20.8 | 4.70 | — |
| 20.81 | 3.00 | — |
| 21.4 | 4.90 | — |
| 21.41 | 3.25 | — |
| 21.9 | 5.10 | — |
| 22.01 | 3.25 | — |
| 22.5 | 5.25 | — |
| 22.51 | 3.25 | — |
| 23.0 | 5.50 | — |
| 23.01 | 3.25 | — |
| 23.6 | 5.50 | — |
| 23.61 | 3.25 | — |
| 24.2 | 5.75 | — |
| 24.21 | 3.50 | — |
| 24.7 | 6.00 | — |
| 24.71 | 3.75 | — |
| 25.3 | 6.25 | — |
| 25.31 | 3.75 | — |
| 25.8 | 6.50 | — |
| 25.81 | 4.25 | — |
| 26.4 | 7.00 | — |
| 26.41 | 4.50 | — |
| 26.9 | 7.50 | — |
| 26.91 | 4.75 | — |
| 27.5 | 8.50 | — |
| 27.51 | 4.75 | — |
| 28.0 | 9.50 | — |
| 28.01 | 5.00 | — |
| 28.6 | 10.75 | — |

CEB

A chart of time versus inlet pressure for the ultrafilter operated under condition 10 is illustrated in FIG. 7H. The inlet pressure increased for each subsequent filtration run, reaching a high of 10.75 psi after about 28.5 hours of operation.

### Condition 11

Purpose of test: Determine if biocide addition would hinder biological growth and not inhibit inlet pressure or run longevity.
Base Solution: Deionized water with copper and peroxide added
Spike Solution: 3.35 mL/L each of slurry samples #11244 and #11245
pH: 6
Backwash frequency: 32 minutes
Flow: 40 GFD

Condition 11 - Standard Run Mode With Biocide

| Run Time | Inlet Pressure | Flow |
|---|---|---|
| (hours) | (PSI) | (GFD) |
| 0.1 | 0.8 | 40 |
| 0.5 | 2 | — |
| 0.51 | 1 | — |
| 1.1 | 2.25 | — |
| 1.11 | 1.25 | — |
| 1.6 | 2.5 | — |
| 1.61 | 1.25 | — |
| 2.2 | 2.5 | — |
| 2.21 | 1.5 | — |
| 2.7 | 2.55 | — |
| 2.71 | 1.75 | — |
| 3.3 | 2.75 | — |
| 3.31 | 1.75 | — |
| 3.8 | 3 | — |
| 3.81 | 1.75 | — |
| 4.3 | 3 | — |
| 4.31 | 2 | — |
| 4.9 | 3.25 | — |
| 4.91 | 2 | — |
| 5.4 | 3.5 | — |
| 5.41 | 1.8 | — |
| 6.0 | 3.25 | — |
| 6.01 | 2 | — |
| 6.6 | 3.5 | — |
| 6.61 | 2.25 | — |
| 7.1 | 4.5 | — |
| 7.11 | 2.25 | — |
| 7.7 | 3.5 | — |
| 7.71 | 2.5 | — |
| 8.2 | 3.75 | — |
| 8.21 | 2.5 | — |
| 8.8 | 4 | — |
| 8.81 | 2.5 | — |
| 9.3 | 4.5 | — |
| 9.31 | 2.5 | — |
| 9.8 | 4.75 | — |
| 9.81 | 2.5 | — |
| 10.4 | 4.25 | — |
| 10.41 | 2.5 | — |
| 11.0 | 5.25 | — |
| 11.01 | 2.75 | — |
| 11.5 | 5 | — |
| 11.51 | 2.75 | — |
| 12.1 | 4.5 | — |
| 12.11 | 2.75 | — |
| 12.6 | 5.25 | — |
| 12.61 | 2.5 | — |
| 13.2 | 5.75 | 41 |
| 13.21 | 2.75 | — |
| 13.7 | 4.75 | — |
| 13.71 | 2.75 | — |
| 14.3 | 4.25 | — |
| 14.31 | 2.75 | — |
| 14.8 | 4.5 | — |
| 14.81 | 2.75 | — |
| 15.4 | 5.5 | — |
| 15.41 | 2.75 | — |
| 15.9 | 5.25 | — |
| 15.91 | 3 | — |
| 16.5 | 5.25 | — |
| 16.51 | 2.75 | — |
| 17.0 | 5.75 | — |
| 17.01 | 3.00 | — |
| 17.6 | 6.25 | — |
| 17.61 | 2.75 | — |
| 18.1 | 5.50 | — |
| 18.11 | 2.25 | — |
| 18.7 | 5.00 | — |
| 18.71 | 2.50 | — |
| 19.2 | 5.75 | — |
| 19.21 | 2.75 | — |
| 19.8 | 4.75 | — |
| 19.81 | 2.75 | — |
| 20.3 | 5.75 | — |
| 20.31 | 3.00 | — |
| 20.9 | 5.50 | — |
| 20.91 | 3.00 | — |
| 21.4 | 5.75 | — |
| 21.41 | 3.00 | — |
| 22.0 | 6.25 | — |
| 22.01 | 3.00 | — |
| 22.5 | 6.50 | 40 |
| 22.51 | 3.00 | — |
| 23.1 | 5.75 | — |
| 23.11 | 2.75 | — |
| 23.6 | 6.25 | — |
| 23.61 | 3.25 | — |
| 24.2 | 7.50 | — |
| 24.21 | 2.75 | — |
| 24.7 | 6.25 | — |
| 24.71 | 3.00 | — |
| 25.3 | 6.00 | — |
| 25.31 | 3.25 | — |
| 25.8 | 6.50 | — |
| 25.81 | 3.00 | — |
| 26.4 | 6.25 | — |
| 26.41 | 2.50 | — |

A chart of time versus inlet pressure for the ultrafilter operated under condition 11 is illustrated in FIG. 7I. The inlet pressure increased for each subsequent filtration run, reaching a high of between 6.0 and 6.5 psi for runs after about 26 hours of operation.

The above examples illustrate the effectiveness of the disclosed ultrafilter for filtering treating aa aqueous waste stream from a copper chemical mechanical polishing process including a concentration of dissolved copper and slurry solids comprising abrasive particles having a number weighted mean size of less than 0.75 μm and for recovering filter porosity and inlet pressure by backwash or chemical clean. Operation under at least some conditions, for example, conditions 6 and 7 provided for the ultrafilter to recover with each backwash to maintain a maximum inlet pressure during filtration of less than about 1.5 psi over an extended number of filtration and backwash cycles.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method for treating an aqueous waste stream from a copper chemical mechanical polishing process including a concentration of dissolved copper and slurry solids comprising abrasive particles having a number weighted mean size of less than 0.75 μm, the method comprising:
introducing the aqueous waste stream into a feed tank;
flowing the aqueous waste stream from the feed tank into an ultrafiltration module;
filtering the aqueous waste stream through a membrane of the ultrafiltration module to form a solids-lean filtrate;
directing the solids-lean filtrate from the ultrafiltration module through an ion exchange unit to remove dissolved copper and produce a treated aqueous solution having a lower copper concentration than the copper concentration of the aqueous waste stream;
backwashing the membrane ultrafiltration module to remove the slurry solids from the membrane of the ultrafiltration module; and
combining the removed slurry solids with the treated aqueous solution to form a combined discharge stream having a copper concentration suitable for discharge into the environment.

2. The method of claim 1, further comprising directing the solids-lean filtrate from the ultrafiltration module into a filtrate holding tank and directing the solids-lean filtrate from the filtrate holding tank to the ion exchange unit.

3. The method of claim 2, wherein backwashing the ultrafiltration module includes backwashing the membrane of the ultrafiltration module with the solids-lean filtrate from the filtrate holding tank.

4. The method of claim 3, further comprising directing the solids-lean filtrate used to backwash the ultrafiltration module and the removed slurry solids into a backwash holding tank.

5. The method of claim 4, further comprising settling the removed slurry solids in the backwash holding tank.

6. The method of claim 5, further comprising directing supernatant from the backwash holding tank into the feed tank.

7. The method of claim 1, further comprising adjusting a pH of the aqueous waste stream in the feed tank.

8. The method of claim 7, wherein adjusting the pH of the aqueous waste stream in the feed tank comprises adjusting the pH of the aqueous waste stream to a pH of about 3.

9. The method of claim 1, wherein filtering the aqueous waste stream through the membrane of the ultrafiltration module include filtering about 40 gallons of the aqueous waste stream per square foot of membrane area per day (GFD) through the membrane of the ultrafiltration module while maintaining an inlet pressure of the ultrafiltration module below about 1.5 pounds per square inch.

10. The method of claim 1, wherein backwashing of the ultrafiltration module is performed after a predetermined amount of time of filtering the aqueous waste stream in each cycle of filtration and backwash.

11. The method of claim 1, wherein introducing the aqueous waste stream into the feed tank includes introducing an aqueous waste stream having a concentration of the abrasive particles with sizes of 0.50 μm and above of at least 10⁶/ml.

12. A method of facilitating treatment of an aqueous waste stream from a copper chemical mechanical polishing process including a concentration of dissolved copper and slurry solids comprising abrasive particles having a number weighted mean size of less than 0.75 μm, the method comprising:
providing an ultrafiltration module, an ion exchange module, and a backwash holding tank;
fluidly connecting the ultrafiltration module upstream of the ion exchange module;
fluidly connecting the backwash holding tank to a backwash outlet of the ultrafiltration module;
fluidly connecting a solids outlet of the backwash holding tank to an outlet of the ion exchange module; and
fluidly connecting a supernatant outlet of the backwash holding tank to an inlet of the ultrafiltration module.

13. A system for treating an aqueous waste stream from a copper chemical mechanical polishing process including a concentration of dissolved copper and slurry solids comprising abrasive particles having a number weighted mean size of less than 0.75 μm, the system comprising:
a feed tank fluidly connectable to a source of the aqueous waste stream;
an ultrafiltration unit having an inlet fluidly connectable to an outlet of the feed tank;
an ion exchange unit including media operable to remove copper from a stream passing through the ion exchange unit and having an inlet fluidly connectable to a filtrate outlet of the ultrafiltration unit; and
a backwash holding tank having an inlet fluidly connectable to a backwash outlet of the ultrafiltration unit, a settled solids outlet fluidly connectable to a purified water outlet of the ion exchange unit, and a supernatant outlet fluidly connectable to the feed tank.

14. The system of claim 13, further comprising a filtrate holding tank fluidly connectable between the filtrate outlet of the ultrafiltration unit and the inlet of the ion exchange unit.

15. The system of claim 14, further comprising a backwash pump configured to direct filtrate from the filtrate holding tank through the ultrafiltration unit and into the backwash holding tank.

16. The system of claim 15, further comprising a controller configured to cause the system to perform a method comprising:
introducing the aqueous waste stream into the feed tank;
flowing the aqueous waste stream from the feed tank into the ultrafiltration unit;
filtering the aqueous waste stream through a membrane of the ultrafiltration unit to form a solids-lean filtrate;
directing the solids-lean filtrate from the ultrafiltration unit through the ion exchange unit to produce a treated aqueous solution having a lower copper concentration than the copper concentration of the aqueous waste stream;
backwashing the membrane of the ultrafiltration unit to remove slurry solids from the membrane of the ultrafiltration unit; and
combining the removed retained solids with the treated aqueous solution to form a combined discharge stream having a copper concentration suitable for discharge into the environment.

17. The system of claim 16, wherein the controller is further configured to cause the system to settle the removed slurry solids in the backwash holding tank.

18. The system of claim 17, wherein the controller is further configured to cause the system to adjust a pH of the aqueous waste stream in the feed tank.

19. The system of claim 18, wherein the controller is further configured to cause the system to adjust the pH of the aqueous waste stream in the feed tank to a pH of about 3.

20. The system of claim 16, wherein the controller is further configured to cause the system to filter about 40 gallons of the aqueous waste stream per square foot of membrane area per day (GFD) through the membrane of the ultrafiltration unit while maintaining an inlet pressure of the ultrafiltration unit below about 1.5 pounds per square inch.
